(19) United States
(12) Patent Application Publication
(10) Pub. No.: US 2021/0118275 A1
(43) Pub. Date: Apr. 22, 2021

(54) SOUND AND OR LIGHT AUTOMATIC VARIATION SYSTEM

(71) Applicants: David Glaubiger, Chatsworth, CA (US); Keith Michael Konheim, Santa Barbara, CA (US)

(72) Inventors: David Glaubiger, Chatsworth, CA (US); Keith Michael Konheim, Santa Barbara, CA (US)

(73) Assignees: David Glaubiger, Chatsworth, CA (US); Keith Michael Konheim, Santa Barbara, CA (US)

(21) Appl. No.: 16/986,003

(22) Filed: Aug. 5, 2020

Related U.S. Application Data
(60) Provisional application No. 62/882,956, filed on Aug. 5, 2019.

(51) Int. Cl. G08B 15/00; G08B 7/06

(52) U.S. Cl. CPC G08B 15/00; G08B 7/06

(57) ABSTRACT

New to the art, which Sound and Or Light Automatic Variation System introduces is both computer controlled volume implemented in a method of varying the volume and changing this volume level to adjacent speakers which creates a sensation of movement of the sound being played. New to the art of strobe lights used to disorientate people or animals as a non-lethal weapon, implemented in a method that varies the frequency with computer control to improve the effectiveness.

### CROSS-REFERENCE TO RELATED APPLICATIONS

This patent application claims the benefit of U.S. Provisional Patent Application Ser. No. 62/882,956, entitled “Sound and Or Light Automatic Variation System,” filed Aug. 5, 2019, which applications are incorporated in their entirety here by this reference.

### BACKGROUND

Notification systems have evolved from the simple bell over a door, activated by the door striking the clapper which in turn strikes mouth of the bell producing the ringing tone announcing a person has entered through the doorway. The ancient version is the typical bell attached to a collar on a cow or Bovine, ringing as the animal moves providing audio notification of an animal's presence.

The purpose and disclosure of this invention is to create new methods of notification for either the home owner, shop keeper, visitor or intruder. This invention may also improve or create a tranquil environment.

Presently Strobe lights are manufactured or produced to emit a fixed frequency. This frequency may be changed with a switch or analog switch or Dial to a Different frequency. This Invention makes an improvement by making this adjustable to vary frequencies through the use of a computer. A computer is implemented to control and vary the frequency.

Presently once volume levels are adjusted, they become fixed. The Invention varies

### SUMMARY

Implementing this invention to create an expanded tranquil environment, a person would set 2 or more speakers surrounding a restful place a person has chosen such as a sofa for example. The sounds played could be Ocean and Wave sounds or Bird sounds. The user would program the Sound and Or Light Automatic Variation System to automatically vary the volume from side to side, possibly alternating between ‘front to back’ or ‘left to right’ providing the sensation that the user is within the environment enhanced with ‘moving’ audio

This invention can be implemented to protect property. With speakers surrounding the exterior of a home, as an intruder moves about the exterior, sounds varying from growling to barking can be played varying in volume from side to side of the position of the intruder to create the impression of a live animal inside.

Speakers can be positioned along a driveway and using sensors, can rotate the sounds of an aggressive animal or animals surrounding a position. The sounds of aggressive animals may create theft deterrence.

Using lights, that may surround a building, as a sensor detects an intruder, the lights may turn on and off at certain frequencies to impair the intruder's orientation. Such frequencies may be 11 Hz or 14 Hz or a combination or variation of frequencies. The user would program these with software that controls the system.

### Construction of Sound and or Light Automatic Variation System

FIG. X depicts the basic parts required to construct the Sound and Or Light Automatic Variation System. The system comprises a computer or microprocessor that plays stored or ‘streamed’ digital audio files or sounds, which may originate from a remote data storage server or location. The sound is distributed to multiple audio amplifiers which are then sent to speakers. The computer controls the volume to each of the amplifier and speaker pairs. Software is configured to vary the volume among the speakers creating the impression of movement of animals or that a person is immersed in an environment such as the sounds of the Ocean or other sounds that are soothing.

The computer or microprocessor is also used to control lights, such as lights on the outside of a building. Not depicted in the figures are the electronic switches used to control the lights as some LED lights or halogen or other types of lights use more current than a microprocessor or computer can supply. The lights are turned on and off at the frequency at which they are pre-programmed. For instance, the user might activate a remote (Radio Frequency) switch which turns some or all lights on without any strobe frequency.

### BRIEF DESCRIPTION OF DRAWINGS

FIG. 1 depicts a Flow Chart or the Algorithm used in implementing Sound and Or Light Automatic Variation System.

FIG. 2 depicts a house with speakers mounted on the exterior of the dwelling.

FIG. 3 depicts s house or dwelling with Strobe or Floodlights mounted on the exterior of the dwelling.

FIG. 4 depicts a house, driveway and car with speakers set along the sides of the driveway.

FIG. 5 depicts components of Sound and Or Light Automatic Variation System.

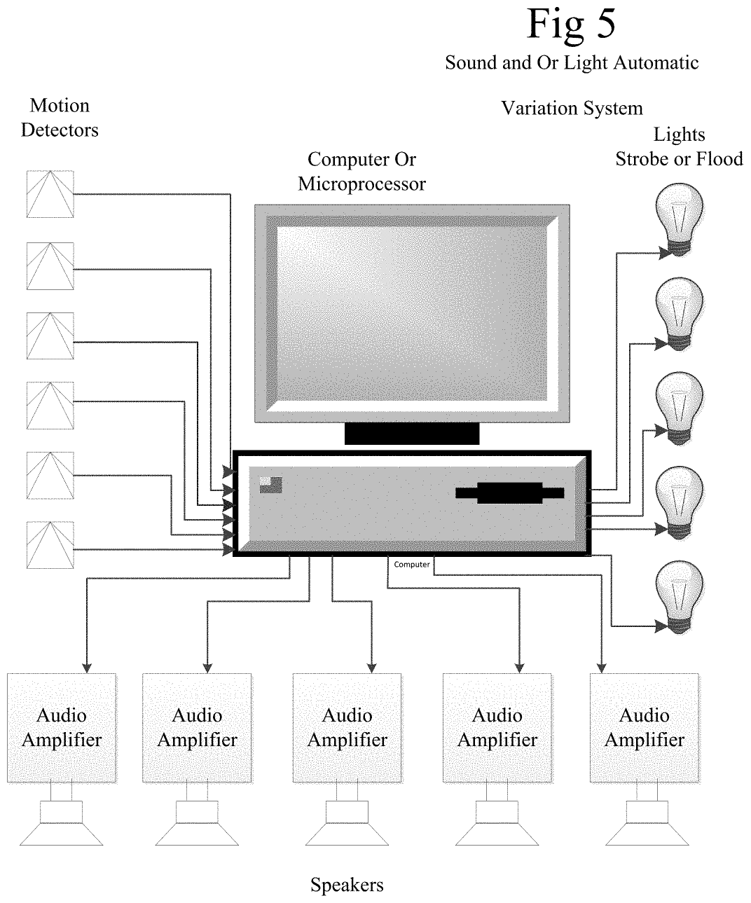

### DETAILED DESCRIPTION OF THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

The present invention may use the term Micro Processor or Computer throughout. FIGS. 0X and 0Y provide the basic Algorithm implemented. Actual computer code is Microprocessor specific and would only work on that model Integrated Circuit. The description here will provide a method for an engineer skilled in the art of programming and electronic design. The beginning building block is an interrupt routine several times faster than both 11 Hz and 14 Hz that provides time to service the other tasks required. 308 Hz was chosen. The value used in the interrupt service routine is a variable, enabling a high resolution variation of frequencies between 11 Hz and 14 Hz. 308 Hz/11 Hz=28 Hz. 308 Hz/14 Hz=22 Hz. An electronic circuit gates these to all the lights with an enable line from the microprocessor or computer.

The audio at present is implemented in a separate microprocessor with a clock speed of 120 Mhz. The decoding of mp3 files is done with software rather than a separate Integrated Chip designed specifically for that task. The audio output generated by the Digital to Analog Converter (DAC) is buffered with a standard Op-Amp, which then is amplified by an IC where the volume is controlled by data written to the IC amplifier over an I2C bus. I2C is a synchronous serial communication bus invented in 1982.

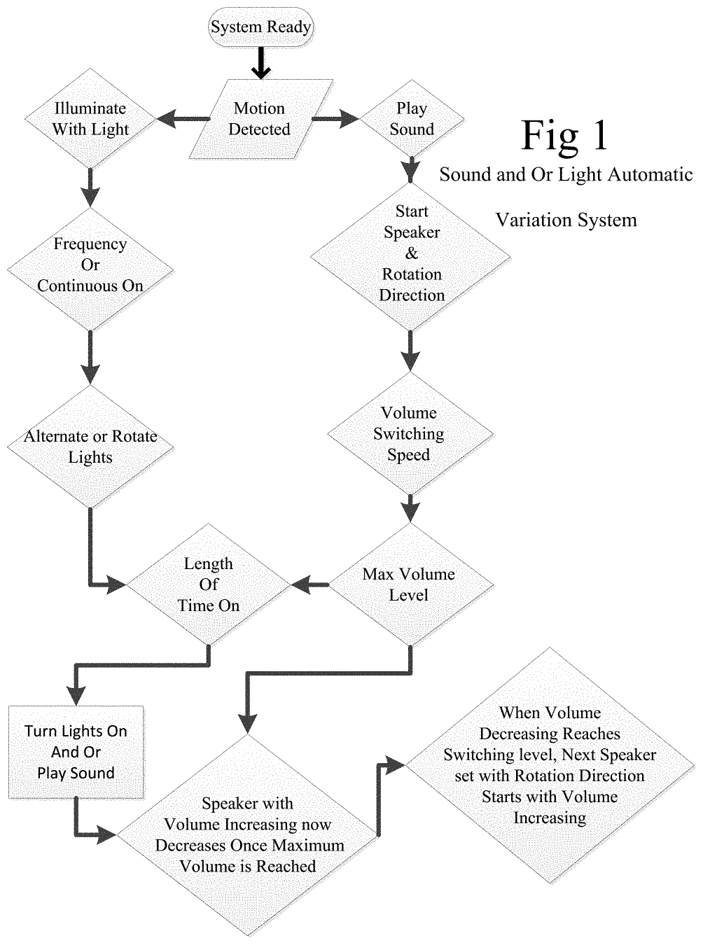

FIG. 1 depicts the basic algorithm implemented. There are several variables used for length of time on, the starting speaker, which direction Clockwise or Counter Clockwise the sound rotates, how fast the volume changes, at what level as the sound is decreasing does the next speaker start playing and the maximum volume.

Overview

Referring to FIG. 1, as a sensor output signals motion has been detected, depending on the value stored as a variable to control Light and or Sound, the computer or microprocessor will either enable strobe lights at a preset possibly varying frequency or start playing a sound file. The Strobe lights are mostly effective between dusk and dawn.

When the system is configured to play an audio file, the system will stream to the configured start speaker or speakers.

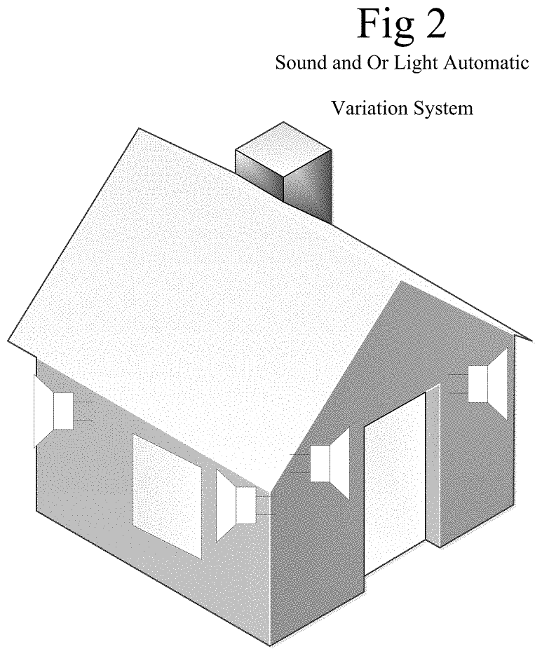

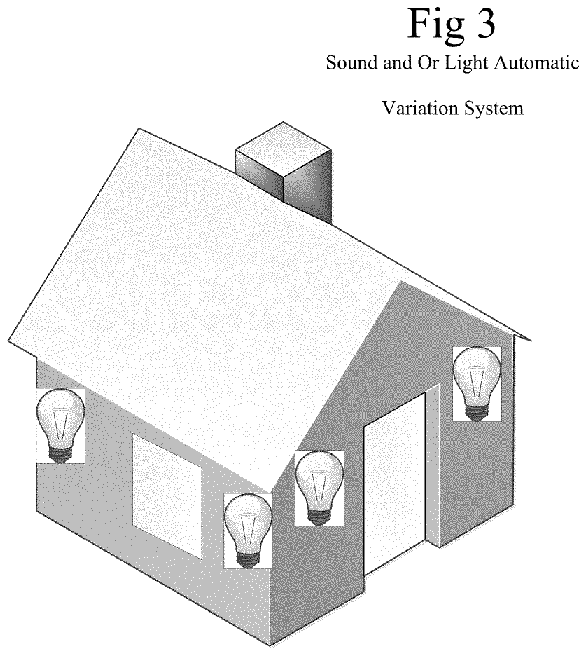

FIGS. 2, 3 and 4 depict various placements of speakers and Strobe or Flood lights. In one embodiment the system could vary the volume between a speaker on the side of a window or door and one on the other side of the house.

In another embodiment the system upon detecting motion could play the sound of a dog barking, switching between speakers on either side of the sensor that detected motion.

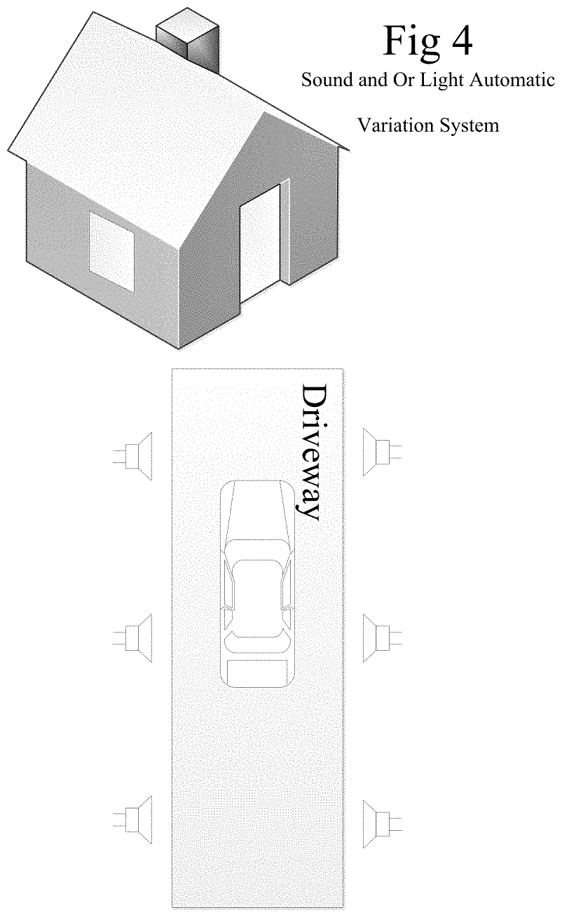

In another embodiment depicted in FIG. 4, the system detecting motion at night, could play sounds of dangerous animals. With the volume increasing and decreasing between neighboring speakers in either a clockwise or counter clockwise rotation direction, the impression that these dangerous animals are circling around the area where motion has been detected can be created.

What is claimed is:

1) A Sound and Or Light Automatic Variation System comprising:
a) Lights, either Strobe or Flood illuminated by a computer controlled and preprogrammed and or at adjustable variable or fixed frequencies, not limited to frequencies such as 11 Hz or 14 Hz or frequencies lower or greater than such frequencies.
b) Speakers driven by computer controlled volume such that the volume is increased on one speaker and after maximum volume is reached the volume decreases. As the volume decreases past a set point, the volume on an adjacent speaker increases creating the illusion of movement.
c) The rotation direction can be configured or programed to switch at any point after any number of speakers have transmitted sound.

2) A Sound and Or Light Automatic Variation System comprising a Motion Trigger:
a) A computer automatically directs the sound or strobe lights to surround the area within which motion has been detected.
b) A computer varies the frequency with which sound or strobe light surrounds the area within which motion has been detected.
